(19) United States
(12) Patent Application Publication
(10) Pub. No.: US 2024/0357585 A1
(43) Pub. Date: Oct. 24, 2024

(54) TERMINAL, RADIO COMMUNICATION METHOD, AND BASE STATION

(71) Applicant: NTT DOCOMO, INC., Tokyo (JP)

(72) Inventors: Yuki Takahashi, Tokyo (JP); Satoshi Nagata, Tokyo (JP); Qiping Pi, Beijing (CN); Jing Wang, Beijing (CN); Lan Chen, Beijing (CN)

(73) Assignee: NTT DOCOMO, INC., Tokyo (JP)

(21) Appl. No.: 18/685,414

(22) PCT Filed: Aug. 17, 2022
(86) PCT No.: PCT/JP2022/031031

§ 371 Date: Feb. 21, 2024

(30) Foreign Application Priority Data
Aug. 25, 2021 (JP) 2021-137354

(51) Int. Cl. H04W 72/1268; H04B 7/06; H04W 72/0446

(52) U.S. Cl. CPC H04W 72/1268; H04B 7/0626; H04W 72/0446

(57) ABSTRACT

A terminal according to an aspect of the present disclosure includes: a receiving section configured to receive a configuration of a physical uplink control channel (PUCCH) for at least one of a scheduling request (SR) and channel state information (CSI); and a control section configured to control respective transmission of a plurality of repetitions of the PUCCH over a plurality of subslots based on the configuration. According to one aspect of the present disclosure, suitable PUCCH repetition transmission can be implemented.

### TECHNICAL FIELD

The present disclosure relates to a terminal, a radio communication method, and a base station in next-generation mobile communication systems.

### BACKGROUND ART

In a universal mobile telecommunications system (UMTS) network, specifications of long term evolution (LTE) have been drafted for the purpose of further increasing data rates, providing low delay, and the like (Non Patent Literature 1). In addition, for the purpose of further increasing capacity and advancement of LTE (third generation partnership project (3GPP) release (Rel.) 8 and 9), the specifications of LTE-Advanced (3GPP Rel. 10 to 14) have been drafted.

Successor systems to LTE (for example, also referred to as 5th generation mobile communication system (5G), 5G+ (plus), 6th generation mobile communication system (6G), New Radio (NR), or 3GPP Rel. 15 and subsequent releases) are also being studied.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

In a future radio communication system (for example, NR), it has been studied that the UE repeatedly transmits a physical uplink control channel (PUCCH) in order to improve reliability of the PUCCH. The repetition transmission of the PUCCH may be referred to as PUCCH repetition.

However, according to previous NR specifications, it is not clear how to determine the resource of each repetition in the subslot-based PUCCH repetition. If this method is not clear, PUCCH repetition cannot be suitably implemented, and communication quality/communication throughput may be deteriorated.

Therefore, an object of the present disclosure is to provide a terminal, a radio communication method, and a base station capable of implementing suitable PUCCH repetition transmission.

### Solution to Problem

A terminal according to an aspect of the present disclosure includes: a receiving section configured to receive a configuration of a physical uplink control channel (PUCCH) for at least one of a scheduling request (SR) and channel state information (CSI); and a control section configured to control respective transmission of a plurality of repetitions of the PUCCH over a plurality of subslots based on the configuration.

### Advantageous Effects of Invention

According to one aspect of the present disclosure, suitable PUCCH repetition transmission can be implemented.

### BRIEF DESCRIPTION OF DRAWINGS

FIG. 1 is a diagram illustrating an example of SR resource configuration.

FIG. 2 is a diagram illustrating an example of CSI report configuration.

FIGS. 3A and 3B are diagrams illustrating an example of configuration of a periodicity and offset, and a PUCCH resource in a CSI report configuration.

FIG. 4 is a diagram illustrating an example of a problem.

FIG. 5 is a diagram illustrating an example of subslot-based PUCCH repetition according to a first embodiment.

FIG. 6 is a diagram illustrating an example of subslot-based PUCCH repetition according to a second embodiment.

FIG. 7 is a diagram illustrating an example of a schematic configuration of a radio communication system according to one embodiment.

FIG. 8 is a diagram illustrating an example of a configuration of a base station according to one embodiment.

FIG. 9 is a diagram illustrating an example of a configuration of a user terminal according to one embodiment.

FIG. 10 is a diagram illustrating an example of a hardware configuration of the base station and the user terminal according to one embodiment.

### DESCRIPTION OF EMBODIMENTS

### (PUCCH Format)

In a future radio communication system (for example, Rel. 15 and subsequent releases, 5G, NR, or the like), a configuration (also referred to as a format, a PUCCH format (PF), or the like) for an uplink control channel (for example, PUCCH) used for transmission of uplink control information (UCI) has been studied. For example, in Rel. 15 NR, it is under study to support five types of PFs which are PF0 to PF4. Note that PF names illustrated below are merely examples, and different names may be used.

For example, PF0 and PF1 are PFs used for transmission of up to two bits of UCI. For example, the UCI may be at least one of delivery acknowledgement information (also referred to as hybrid automatic repeat request-acknowledgement (HARQ-ACK), acknowledgement (ACK) or negative-acknowledgement (NACK), or the like) and a scheduling request (SR). Since it is possible to allocate PF0 to one or two symbols, PF0 is also referred to as a short PUCCH, a sequence-based short PUCCH, or the like. Meanwhile, since it is possible to allocate PF1 to four to 14 symbols, PF1 is also referred to as a long PUCCH or the like. PF0 may use a cyclic shift based on at least one of an initial cyclic shift (CS) index, a value of UCI, a slot number, and a symbol number, and transmit a sequence obtained by a cyclic shift of a base sequence. In PF1, code division multiplexing (CDM) may be performed on a plurality of user terminals in the same physical resource block (PRB) by block spreading in time domain using at least one of CS and time domain (TD)-orthogonal cover code (OCC).

PF2 to PF4 are PFs used for transmission of more than two bits of UCI (for example, channel state information (CSI), or at least one of CSI, HARQ-ACK, and SR). Since it is possible to allocate PF2 to one or two symbols, PF2 is also referred to as a short PUCCH or the like. Meanwhile, since it is possible to allocate PF3 and PF4 to four to 14 symbols, PF3 and PF4 are also referred to as long PUCCHs or the like. In PF4, CDM may be performed on a plurality of user terminals by using block spreading (in a frequency domain (FD)-OCC) before DFT.

Intra-slot frequency hopping may be applied to PF1, PF3, and PF4. When the length of the PUCCH is N_{symb}, the length before frequency hopping (first hop) may be floor (N_{symb}/2), and the length after frequency hopping (second hop) may be ceil (N_{symb}/2).

The waveforms of PF0, PF1, and PF2 may be cyclic prefix (CP)-orthogonal frequency division multiplexing (OFDM). The waveforms of PF3 and PF4 may be discrete Fourier transform (DFT)-spread(s)-OFDM.

Allocation of resources (for example, PUCCH resources) for use in transmission of the uplink control channel is performed using higher layer signaling and/or downlink control information (DCI). Here, for example, the higher layer signaling just needs to be at least one of radio resource control (RRC) signaling, system information (for example, at least one of remaining minimum system information (RMSI), other system information (OSI), master information block (MIB), and system information block (SIB), and broadcast information (physical broadcast channel (PBCH)).

In addition, in NR, the number of symbols (which may be referred to as PUCCH allocation symbols, PUCCH symbols, or the like) allocated to the PUCCH can be determined according to any one of or a combination of slot specific, cell specific, and user terminal specific. Since it is expected that a communication distance (coverage) increases as the number of PUCCH symbols increases, for example, an operation in which the number of symbols is increased for user terminals farther from a base station (for example, eNB or gNB) is assumed.

### (PUSCH Repetition Transmission)

In Rel. 15, repetition transmission is supported in data transmission. For example, a base station (network (NW), gNB) may repeatedly transmit DL data (for example, downlink shared channel (PDSCH)) for a certain number of times. Alternatively, a UE may repeat UL data (for example, uplink shared channel (PUSCH)) for a certain number of times.

The UE may be scheduled for a certain number of repeated PUSCH transmissions by a single DCI. The number of repetitions is also referred to as a repetition factor K or an aggregation factor K.

In addition, an n-th repetition is also referred to as an n-th transmission occasion, and the like, and may be identified by a repetition index k (0≤k≤K−1). Repetition transmission may be applied to a PUSCH dynamically scheduled by DCI (for example, a dynamic grant-based PUSCH), or may be applied to a configured grant-based PUSCH.

The UE semi-statically receives information indicating the repetition factor K (for example, aggregationFactorUL or aggregationFactorDL) by higher layer signaling. Here, higher layer signaling may be, for example, any of radio resource control (RRC) signaling, medium access control (MAC) signaling, broadcast information, and the like, or a combination thereof.

For example, a MAC control element (MAC CE), a MAC protocol data unit (PDU), or the like may be used for the MAC signaling. The broadcast information may be, for example, a master information block (MIB), a system information block (SIB), remaining minimum system information (RMSI), or the like.

The UE controls PDSCH reception processing (for example, at least one of reception, demapping, demodulation, or decoding) or a PUSCH transmission processing (for example, at least one of transmission, mapping, modulation, or encoding) in the K consecutive slots on the basis of at least one of the following field values (or information indicated by the field value) in the above DCI:
the allocation of time domain resource (such as the start symbol and the number of symbols in each slot, for example),
the allocation of frequency domain resource (for example, a certain number of resource blocks (RBs) or a certain number of resource block groups (RBGs)),
the modulation and coding scheme (MCS) index,
the configuration of the demodulation reference signal (DMRS) of the PUSCH, or
Spatial relation info of PUSCH, or the state (TCI state) of the transmission configuration indication or transmission configuration indicator (TCI).

The same symbol allocation may be applied between consecutive K slots. The UE may determine the symbol allocation in each slot based on the start symbol S and the number of symbols L (for example, start and length indicator (SLIV)) determined based on the value m of a certain field (for example, a time domain resource allocation (TDRA) field) in the DCI. Note that the UE may determine the first slot based on the K2 information determined based on the value m of a certain field (for example, the TDRA field) of the DCI.

On the other hand, the redundancy versions (RVs) applied to the TBs based on the same data may be the same or at least partially different between the consecutive K slots. For example, the RV applied to the TB in the n-th slot (transmission occasion, repetition) may be determined based on the value of a certain field (for example, the RV field) in the DCI.

In Rel. 15, a PUSCH may be repeatedly transmitted over a plurality of slots (in units of slots). In Rel. 16 and later, it is supported to repeatedly transmit a PUSCH in a unit shorter than a slot (for example, in units of subslots, in units of minislots, or in units of a certain number of symbols).

The UE may determine the symbol allocation of PUSCH transmission (for example, PUSCH with k=0) in a certain slot based on the start symbol S and the number of symbols L determined based on the value m of a certain field (for example, the TDRA field) in the DCI of the PUSCH. Note that the UE may determine the certain slot based on the Ks information determined based on the value m of the certain field (for example, the TDRA field) of the DCI.

The UE may dynamically receive information indicating repetition factor K (for example, numberofrepetitions) using downlink control information. The repetition factor may be determined based on the value m in the certain field (for example, TDRA field) in the DCI. For example, a table in which correspondence between the bit value notification of which is performed by the DCI and the repetition factor K, the start symbol S, and the number of symbols L is defined may be supported.

The slot-based repetition transmission may be referred to as a repetition transmission type A (for example, PUSCH repetition Type A), and the subslot-based repetition transmission may be referred to as a repetition transmission type B (for example, PUSCH repetition Type B).

The UE may be configured to apply at least one of a repetition transmission type A and a repetition transmission type B. For example, notification of the repetition transmission type applied by the UE may be performed from the base station to the UE using higher layer signaling (for example, PUSCHRepTypeIndicator).

Either one of the repetition transmission type A or the repetition transmission type B may be configured in the UE for each DCI format scheduling the PUSCH.

For example, for the first DCI format (for example, DCI format 0_1), if higher layer signaling (for example, PUSCHRepTypeIndicator-AorDCIFormat0_1) is configured to the repetition transmission type B (for example, PUSCH-RepTypeB), the UE applies the repetition transmission type B for the PUSCH repetition transmission scheduled in the first DCI format. Otherwise (for example, in a case where PUSCH-RepTypeB is not configured or in a case where PUSCH-RepTypA is configure), the UE applies repetition transmission type A for the PUSCH repetition transmission scheduled in the first DCI format.

### (Slot-Based PUCCH Repetition)

Slot-based PUCCH repetition is supported in Rel. 15/16 PUCCH format 1/3/4.

PUCCH configuration PUCCH-Config may include a PUCCH format configuration (format 1, format 3, format 4, PUCCH-FormatConfig) and one or more PUCCH resource information elements (PUCCH-Resource). PUCCH-FormatConfig may include the number of slots nrofSlots. PUCCH-Resource may include any one of a PUCCH format 1 information element PUCCH-format1, a PUCCH format 3 information element PUCCH-format3, and a PUCCH format 4 information element PUCCH-format4. Each of PUCCH-format1, PUCCH-format3, and PUCCH-format4 may include the number of symbols nrofsymbols and a start symbol index startingSymbolIndex.

For a PUCCH format 1, 3, or 4, the UE may configure a PUCCH repetition number N_PUCCH\hat{ }repeat for repetition of PUCCH transmission by a respective number-of-slots information element nrofSlots.

If N_PUCCH\hat{ }repeat>1, the UE follows the following regulations 1-1 to 1-3.

### [Regulation 1-1]

The UE repeats PUCCH transmission with UCI over N_PUCCH\hat{ }repeat slots.

### [Regulation 1-2]

PUCCH transmissions in each of the N_PUCCH\hat{ }repeat slots have the same number of consecutive symbols. The number of symbols is provided by the number-of-symbols information element nrofsymbols in the PUCCH format 1 information element PUCCH-format1, the number-of-symbols information element nrofsymbols in the PUCCH format 3 information element PUCCH-format3, or the number-of-symbols information element nrofsymbols in the PUCCH format 4 information element PUCCH-format4.

### [Regulation 1-3]

PUCCH transmission in each of the N_PUCCH\hat{ }repeat slots has the same first symbol (start symbol index). The first symbol is provided by a start symbol index information element startingSymbolIndex in the PUCCH format 1 information element PUCCH-format1, a start symbol index information element startingSymbolIndex in the PUCCH format 3 information element PUCCH-format3, or a start symbol index information element startingSymbolIndex in the PUCCH format 4 information element PUCCH-format4.

### (Subslot-Based PUCCH)

In Rel. 16, a subslot-based HARQ-ACK PUCCH is supported.

If the UE is provided with two PUCCH configurations PUCCH-Config, the PUCCH resource for the HARQ-ACK is defined based on the subslot unit (by the relative location to the first symbol of the subslot) and the PUCCH resource for the other UCI type (SR/CSI) is defined based on the slot unit (by the relative location to the first symbol of the slot).

If the UE is provided with subslotLengthForPUCCH in PUCCH-Config, the first symbol of the PUCCH resource in PUCCH-Config for multiplexing HARQ-ACKs in the PUCCH transmission is a relative value (expressed as a relative value) to the first symbol of the subslotLengthForPUCCH symbols. In the remaining case, the first symbol of the PUCCH resource is a relative value (expressed as a relative value) to the first symbol of the slot having N_sym\hat{ }slot (number of in-slot symbols) symbols.

Even if the PUCCH resource for SR/CSI is defined based on the slot unit, if a subslot is configured for PUCCH-Config with the same priority index, the PUCCH resource for CSI is limited within the subslot.

If the UE is provided with two PUCCH configurations PUCCH-Config, the UE follows the following regulations 2-1 to 2-2.

### [Regulation 2-1]

If the UE is provided with a subslot length subslotLengthForPUCCH in the first PUCCH-Config, a PUCCH resource for any scheduling request (SR) configuration with a priority index of 0 or a channel state information (CSI) report configuration in any PUCCH-Config is in subslotLengthForPUCCH in the first PUCCH-Config.

### [Regulation 2-2]

If the UE is provided with a subslot length subslotLengthForPUCCH in the second PUCCH-Config, a PUCCH resource for any scheduling request (SR) configuration with a priority index of 1 or a channel state information (CSI) report configuration in any PUCCH-Config is in the subslotLengthForPUCCH in the second PUCCH-Config.

### (SR Resource Configuration)

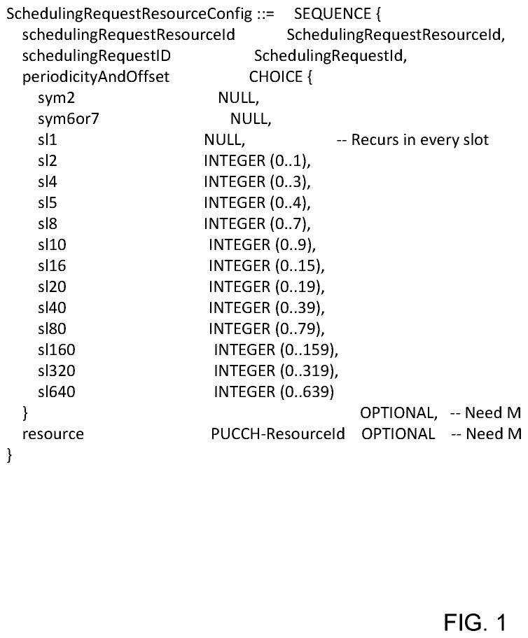

The PUCCH configuration may include one or more SR resource configurations (SchedulingRequestResourceConfig). SchedulingRequestResourceConfig includes an information element (periodicityAndOffset) indicating an SR periodicity (SR_PERIODICITY) and an SR offset (SR_OFFSET), and a PUCCH resource ID (PUCCH-ResourceId) (FIG. 1). One value (candidate value) of periodicityAndOffset indicates the number of slots or the number of symbols in the periodicity and the number of slots with an offset smaller than the periodicity or no offset. Based on SR_PERIODICITY, the SR transmission occasion in the PUCCH follows the following SR transmission occasion determination methods 1 to 3.

### [SR Transmission Occasion Determination Method 1]

When SR_PERIODICITY is greater than one slot, if mod SR_PERIODICITY=0 (n_f*N_slot\hat{ }frame, μ+n_s, f\hat{ }μ−SR_OFFSET), the UE judges that the SR transmission occasion in the PUCCH is in a slot with number (in-frame slot number) n_s, f\hat{ }μ in the frame with number (frame number) n_f.

### [SR Transmission Occasion Determination Method 2]

When SR_PERIODICITY is one slot, the UE assumes that SR_OFFSET=0 and all slots are SR transmission occasion in the PUCCH.

### [SR Transmission Occasion Determination Method 3]

When SR_PERIODICITY is smaller than 1 slot, if (1-1_0 mod SR_PERIODICITY)=0, the UE judges that the SR transmission occasion in the PUCCH starts in the symbol with index 1. Here, 1_0 is a value of startingSymbolIndex.

### (CSI PUCCH Report Configuration)

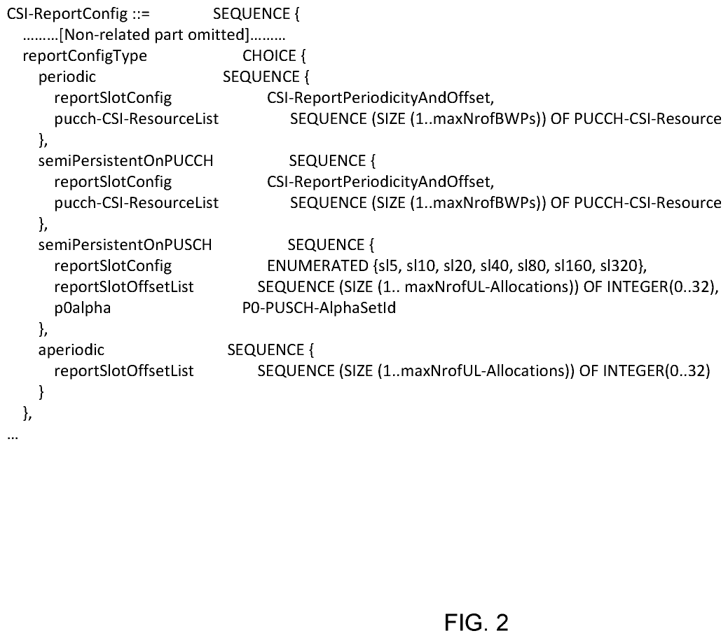

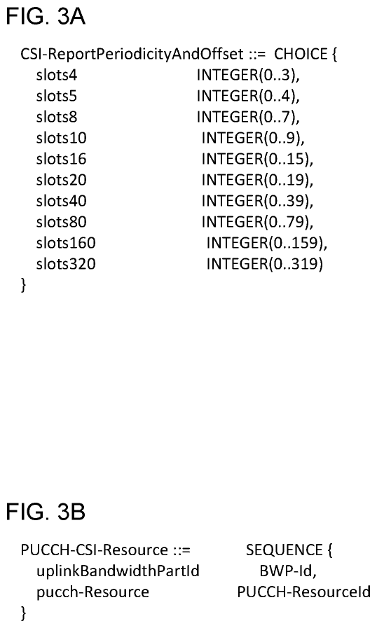

The CSI report configuration (CSI-ReportConfig) includes a report configuration type (reportConfigType) (FIG. 2). When reportConfigType is periodic reporting (periodic) or semi-persistent reporting on PUCCH (semiPersistentOnPUCCH), the information element for the report configuration type includes an information element (reportSlotConfig, CSI-ReportPeriodicityAndOffset, FIG. 3A) indicating a periodicity and an offset of CSI reporting (a slot of CSI reporting) and an information element (PUCCH-CSI-Resource, FIG. 3B) indicating a PUCCH resource for CSI. One value (candidate value) of CSI-ReportPeriodicityAndOffset indicates the number of slots of the periodicity and the number of slots of the offset Smaller than the Periodicity.

(Subslot-Based PUCCH repetition)

Extension of UE feedback for HARQ-ACK has been studied for extension of Industrial Internet of Things (IoT) and ultra-reliable and low latency communication (URLLC).

In Rel. 17, it has been studied to support subslot-based PUCCH repetition. For example, replacing slot-based PUCCH repetition of Rel. 16 with subslot as appropriate has been studied.

If subslot-based PUCCH repetition is supported for CSI/SR, startingSymbolIndex for the PUCCH resource of the CSI and SR is a relative value to the first symbol of the slot, even if subslot is configured according to the interpretation of startingSymbolIndex in Rel. 16. If the “slot” is simply replaced with the “subslot” in the slot-based PUCCH repetition procedure, since startingSymbolIndex for the PUCCH resource of the CSI and SR is a relative value to the first symbol of the slot, it is considered that the first symbol for each PUCCH repetition provided by startingSymbolIndex does not function. Therefore, in order to support subslot-based PUCCH repetition for CSI and SR, it is necessary to change the specification.

If a method for determining resources of the subslot-based PUCCH repetition is not clear, transmission/reception of the PUCCH is not appropriately performed, and communication quality/communication throughput may be deteriorated.

Therefore, the present inventors have conceived a method for implementing suitable PUCCH repetition transmission.

Hereinafter, embodiments according to the present disclosure will be described in detail with reference to the drawings. Radio communication methods according to the respective embodiments may be applied singly or in combination.

In the present disclosure, “A/B/C” and “at least one of A, B and C” may be replaced with each other. In the present disclosure, the cell, the serving cell, the CC, the carrier, the BWP, the DL BWP, the UL BWP, the active DL BWP, the active UL BWP, and the band may be replaced with each other. In the present disclosure, the index, the ID, the indicator, the resource ID may be replaced with each other. In the present disclosure, the sequence, the list, the set, the group, the cohort, the cluster, the subset, and the like may be replaced with each other. In the present disclosure, support, control, controllable, operate, and operable may be replaced with each other.

In the present disclosure, configure, activate, update, indicate, enable, specify, and select may be replaced with each other.

In the present disclosure, the higher layer signaling may be any of, for example, radio resource control (RRC) signaling, medium access control (MAC) signaling, broadcast information, and the like, or a combination thereof. In the present disclosure, the RRC, the RRC signaling, the RRC parameter, the higher layer, the higher layer parameter, the RRC information element (IE), the RRC message, and the configuration may be replaced with each other.

For the MAC signaling, for example, a MAC control element (MAC CE), a MAC protocol data unit (PDU), or the like may be used. In the present disclosure, the MAC CE, the update command, and the activation/deactivation command may be replaced with each other.

The broadcast information may be, for example, a master information block (MIB), a system information block (SIB), remaining minimum system information (RMSI, SIB1), other system information (OSI), or the like.

In the present disclosure, slot-based PUCCH repetition may be transmitting a plurality of repetitions of a PUCCH (UCI) over a plurality of slots. In the present disclosure, subslot-based PUCCH repetition may be transmitting a plurality of repetitions of a PUCCH (UCI) over a plurality of subslots.

In the present disclosure, at least one of UCI, SR, and CSI, SR, and CSI may be replaced with each other.

In the present disclosure, the slot length, the number of in-slot symbols, and the number of in-slot symbols for a certain subcarrier interval may be replaced with each other. The subslot length, the number of in-subslot symbols, and the number of in-subslot symbols for a certain subcarrier interval may be replaced with each other.

In the present disclosure, the number of repetitions, the number of slots, and the number of subslots may be replaced with each other. The number of repetitions for slot-based PUCCH repetition and the number of slots in the PUCCH configuration may be replaced with each other. The number of repetitions for subslot-based PUCCH repetition, the number of slots in the PUCCH configuration, and the number of subslots in the PUCCH configuration may be replaced with each other.

In the present disclosure, the SR PUCCH configuration, the SR resource configuration, SchedulingRequestResourceConfig, the CSI PUCCH configuration, the CSI report configuration, and the CSI-ReportConfig may be replaced with each other.

In the present disclosure, the periodicity, the SR periodicity, the number of slots of the periodicity, and the number of subslots of the periodicity may be replaced with each other. In the present disclosure, the offset, the SR offset, the number of slots of the offset, and the number of subslots of the offset may be replaced with each other.

In the present disclosure, at least one of a PUCCH configuration for at least one of SR and CSI, a PUCCH configuration (for example, the number of slots, a start symbol index, an SR resource configuration, and a subslot-based PUCCH repetition configuration), and a CSI report configuration may be replaced with each other.

In the present disclosure, at least one of the SR resource configuration, the CSI report configuration, the periodicity, and the offset, the occasion, the PUCCH (transmission) occasion, the SR (transmission) occasion, and the CSI (transmission) occasion may be replaced with each other.

### (Radio Communication Method)

### First Embodiment

The first symbol (start symbol, startingSymbolIndex) of the PUCCH resource for CSI/SR may be defined as a relative value (relative location) to the first symbol of the subslot.

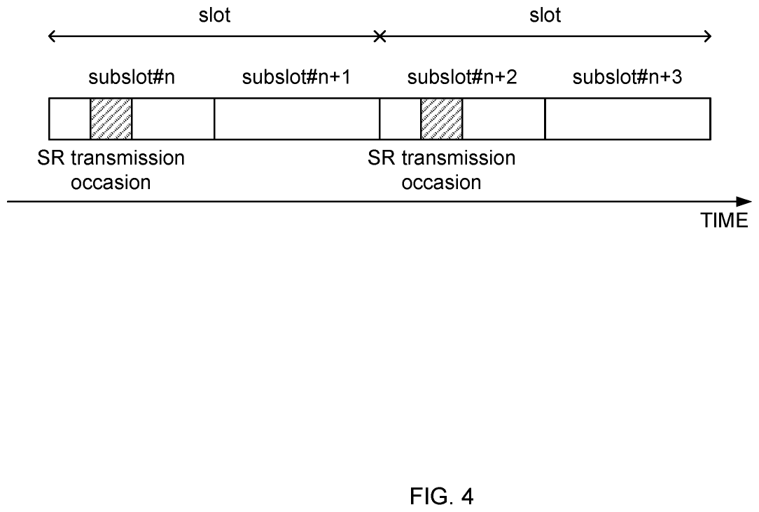

In this case, it is conceivable to deal with the following problems.
The periodicity and offset configuration (for example, periodicityAndOffset, CSI-ReportPeriodicityAndOffset) for at least one of the SR PUCCH configuration (SR resource configuration, SchedulingRequestResourceConfig) and the CSI PUCCH configuration (CSI report configuration, CSI-ReportConfig) needs to be changed according to the subslot-based PUCCH repetition.
According to the foregoing SR transmission occasion determination method 1/2/3, when the periodicity of the SR/CSI is greater than or equal to one slot, the transmission occasion of the SR/CSI cannot be configured in a subslot that is less than or equal to the first subslot of the slot.
As illustrated in the example of FIG. 4, if the value range of startingSymbolIndex is not greater than the subslot length, the SR occasion occurs only in the first subslot.

The periodicity and offset configuration (for example, periodicityAndOffset, CSI-ReportPeriodicityAndOffset) for at least one of the SR PUCCH configuration (SR resource configuration, SchedulingRequestResourceConfig) and the CSI PUCCH configuration (CSI report configuration, CSI-ReportConfig) may be defined based on the subslot unit.

For at least one of periodicityAndOffset in SchedulingRequestResourceConfig and CSI-ReportPeriodicityAndOffset, a new candidate value defined based on the subslot unit may be introduced. The new candidate value of the periodicity/offset may be the number of subslots. For example, the new candidate value of the periodicity may be a candidate value (for example, sub-sl1) representing one subslot, a candidate value (for example, sub-sl4) representing four subslots, or the like. SR periodicity shorter than one subslot may not be supported.

An existing candidate value may be reused for at least one of periodicityAndOffset in SchedulingRequestResourceConfig and CSI-ReportPeriodicityAndOffset. The interpretation of the existing candidate value may be based on the subslot unit instead of the slot unit. A candidate value (For example, 2/6/7 symbols) of the SR periodicity at the symbol level may be ignored. A numerical value (the number of slots) in the existing candidate value may be interpreted as the number of subslots. For example, in a case where a value (sl4 or slot4) indicating four slots is configured for the periodicity, the UE may interpret that the periodicity is four subslots.

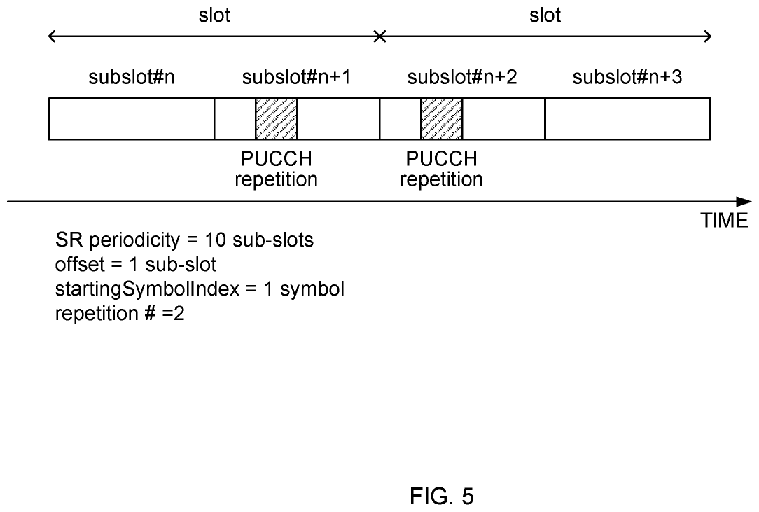

In the example of FIG. 5, the SR PUCCH configuration indicates SR periodicity=10 subslots and SR offset=1 subslot, and the PUCCH configuration indicates startingSymbolIndex=1 symbol and the number of repetitions=2. The UE may determine the start symbol index of each repetition based on the SR PUCCH configuration.

In accordance with this embodiment, the UE may properly determine the first symbol of the PUCCH resource for CSI/SR based on the subslot.

### Second Embodiment

The first symbol (start symbol, startingSymbolIndex) of the PUCCH resource for CSI/SR may be defined as a relative value (relative location) to the first symbol of the slot.

In this case, instead of simply replacing “slot” with “subslot”, the determination of the time domain resource for each repetition is preferably adjusted.

The determination of the first symbol of each repetition of SR/CSI may be according to any one of the following options 1 and 2.

### [Option 1]

The first symbol index of each repetition may be directly defined. A formula for calculating the first symbol index of each repetition may be defined. For example, the first symbol index of the nth repetition of SR/CSI may be given by (startingSymbolIndex+n*subslot length) mod slot length (remainder).

### [Option 2]

A symbol offset (number of symbols, offset from first symbol of subslot to first symbol of each repetition) from the first symbol of each iteration to the first symbol of the subslot may be defined. The offset from the first symbol of the repetition to the first symbol of the subslot may be given by startingSymbolIndex mod subslot length (remainder).

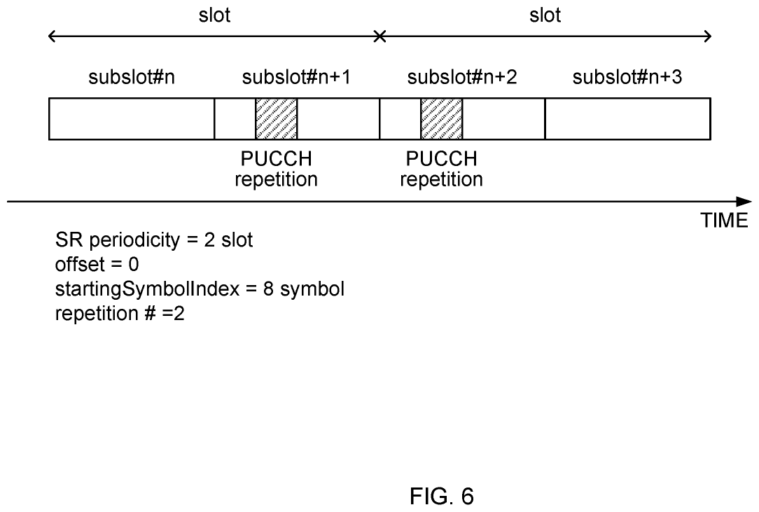

In the example of FIG. 6, the SR PUCCH configuration indicates SR periodicity=2 slots and SR offset=0 (0 slot), and the PUCCH configuration indicates startingSymbolIndex=8 symbols and the number of repetitions=2. The UE may determine the start symbol index of each repetition based on the SR PUCCH configuration.

In accordance with this embodiment, the UE may properly determine the first symbol of the PUCCH resource for CSI/SR based on the slot.

### Other Embodiments

### <Variations>

When subslotLengthForPUCCH is configured for PUCCH-Config corresponding to a PUCCH, any of the foregoing embodiments may be applied to the PUCCH.

When subslotLengthForPUCCH is configured for PUCCH-Config corresponding to a PUCCH, and subslot-based PUCCH repetition for a PUCCH of CSI/SR is enabled/configured/reported by a UE capability/higher layer parameter, any of the foregoing embodiments may be applied to the PUCCH.

### <UE Capability Information/Higher Layer Parameter>

Among the foregoing plurality of embodiments, which embodiment/option/function is used may be configured by higher layer parameters, may be reported by the UE as UE capability, may be defined in a specification, or may be determined by the reported UE capability and configuration of the higher layer parameters.

A higher layer parameter (RRC IE)/UE capability corresponding to a function (feature) in each of the above embodiments may be defined. The higher layer parameter may indicate whether or not the function is enabled. The UE capability may indicate whether the UE supports the function.

The UE in which the higher layer parameter corresponding to the function is configured may perform the function. “The UE in which the higher layer parameter corresponding to the function is not configured does not perform the function (for example, according to Rel. 15/16)” may be defined.

The UE that has reported the UE capability indicating support for the function may perform the function. “The UE that does not report the UE capability indicating support for the function does not perform the function (for example, according to Rel. 15/16)” may be defined.

When the UE reports the UE capability indicating to support the function, and a higher layer parameter corresponding to the function is configured, the UE may perform the function. “When the UE does not report the UE capability indicating to support the function or the higher layer parameter corresponding to the function is not configured, the UE does not perform the function (for example, according to Rel. 15/16)” may be defined.

The UE capability may indicate whether or not the UE supports subslot-based PUCCH repetition.

The UE capability may indicate whether or not the UE supports slot-based PUCCH repetition and subslot-based PUCCH repetition for a CSI/SR.

The UE capability may indicate whether or not the UE supports PUCCH configuration of an SR/CSI using a subslot in units of periodicity and offset.

According to the above UE capability/higher layer parameters, the UE can realize the above functions while maintaining compatibility with existing specifications.

### (Radio Communication System)

Hereinafter, a configuration of a radio communication system according to one embodiment of the present disclosure will be described. In this radio communication system, communication is performed using any one of the radio communication methods according to the embodiments of the present disclosure or a combination thereof.

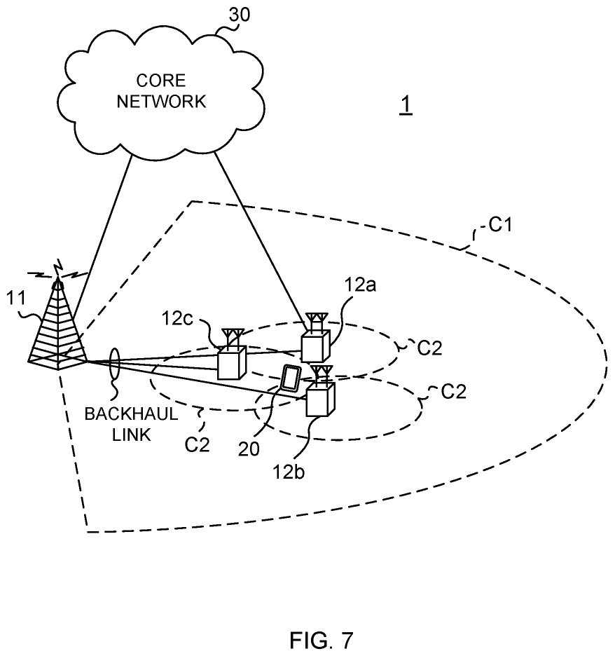

FIG. 7 is a diagram illustrating an example of a schematic configuration of the radio communication system according to one embodiment. A radio communication system 1 may be a system that implements communication using long term evolution (LTE), 5th generation mobile communication system New Radio (5G NR), and the like drafted as the specification by third generation partnership project (3GPP).

Furthermore, the radio communication system 1 may support dual connectivity between a plurality of radio access technologies (RATs) (multi-RAT dual connectivity (MR-DC)). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is MN, and an LTE (E-UTRA) base station (eNB) is SN. The radio communication system 1 may support dual connectivity between a plurality of base stations in the same RAT (for example, dual connectivity in which both MN and SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are disposed within the macro cell C1 and that form small cells C2 narrower than the macro cell C1. A user terminal 20 may be positioned in at least one cell. The arrangement, number, and the like of cells and the user terminals 20 are not limited to the aspects illustrated in the drawings. Hereinafter the base stations 11 and 12 will be collectively referred to as “base stations 10” when the base stations 11 and 12 are not distinguished from each other.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a first frequency band (frequency range 1 (FR1)) or a second frequency band (frequency range 2 (FR2)). The macro cell C1 may be included in FR1, and the small cell C2 may be included in FR2. For example, FR1 may be a frequency band of 6 GHz or less (sub-6 GHZ), and FR2 may be a frequency band higher than 24 GHZ (above-24 GHZ). Note that the frequency bands, definitions, and the like of FR1 and FR2 are not limited to these, and for example, FR1 may be a frequency band higher than FR2.

Further, the user terminal 20 may perform communication on each CC using at least one of time division duplex (TDD) or frequency division duplex (FDD).

The plurality of base stations 10 may be connected to each other in a wired manner (for example, an optical fiber, an X2 interface, or the like in compliance with common public radio interface (CPRI)) or in a wireless manner (for example, NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of evolved packet core (EPC), 5G core network (5GCN), next generation core (NGC), or the like.

The user terminal 20 may correspond to at least one of communication methods such as LTE, LTE-A, and 5G.

In the radio communication system 1, a radio access method based on orthogonal frequency division multiplexing (OFDM) may be used. For example, in at least one of downlink (DL) or uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. Note that in the radio communication system 1, another radio access method (for example, another single carrier transmission method or another multi-carrier transmission method) may be used as the UL and DL radio access method.

In the radio communication system 1, a downlink shared channel (physical downlink shared channel (PDSCH)) shared by the user terminals 20, a broadcast channel (physical broadcast channel (PBCH)), a downlink control channel (physical downlink control channel (PDCCH)), and the like may be used as downlink channels.

In the radio communication system 1, an uplink shared channel (physical uplink shared channel (PUSCH)) shared by the user terminals 20, an uplink control channel (physical uplink control channel (PUCCH)), a random access channel (physical random access channel (PRACH)), and the like may be used as uplink channels.

User data, higher layer control information, a system information block (SIB), and the like are transmitted on the PDSCH. The PUSCH may transmit the user data, higher layer control information, and the like. Furthermore, a master information block (MIB) may be transmitted on the PBCH.

Lower layer control information may be transmitted on the PDCCH. The lower layer control information may include, for example, downlink control information (DCI) including scheduling information of at least one of the PDSCH or the PUSCH.

Note that DCI that schedules PDSCH may be referred to as DL assignment, DL DCI, or the like, and DCI that schedules PUSCH may be referred to as UL grant, UL DCI, or the like. Note that PDSCH may be replaced with DL data, and PUSCH may be replaced with UL data.

For detection of the PDCCH, a control resource set (CORESET) and a search space may be used. The CORESET corresponds to a resource that searches for DCI. The search space corresponds to a search area and a search method for PDCCH candidates. One CORESET may be associated with one or more search spaces. UE may monitor CORESET associated with a certain search space based on search space configuration.

One search space may correspond to a PDCCH candidate corresponding to one or more aggregation levels. One or more search spaces may be referred to as a search space set. Note that “search space”, “search space set”, “search space configuration”, “search space set configuration”, “CORESET”, “CORESET configuration”, and the like in the present disclosure may be replaced with each other.

Uplink control information (UCI) including at least one of channel state information (CSI), delivery acknowledgement information (which may be referred to as, for example, hybrid automatic repeat request acknowledgement (HARQ-ACK), ACK/NACK, or the like), or scheduling request (SR) may be transmitted on the PUCCH. A random access preamble for establishing connection with a cell may be transmitted on the PRACH.

Note that in the present disclosure, downlink, uplink, and the like may be expressed without “link”. Various channels may be expressed without adding “physical” at the beginning thereof.

In the radio communication system 1, a synchronization signal (SS), a downlink reference signal (DL-RS), and the like may be transmitted. In the radio communication system 1, a cell-specific reference signal (CRS), a channel state information reference signal (CSI-RS), a demodulation reference signal (DMRS), a positioning reference signal (PRS), a phase tracking reference signal (PTRS), or the like may be transmitted as the DL-RS.

The synchronization signal may be, for example, at least one of a primary synchronization signal (PSS) or a secondary synchronization signal (SSS). A signal block including the SS (PSS or SSS) and the PBCH (and the DMRS for the PBCH) may be referred to as an SS/PBCH block, an SS block (SSB), or the like. Note that, the SS, the SSB, or the like may also be referred to as a reference signal.

Furthermore, in the radio communication system 1, a measurement reference signal (sounding reference signal (SRS)), a demodulation reference signal (DMRS), or the like may be transmitted as an uplink reference signal (UL-RS). Note that, DMRSs may be referred to as “user terminal-specific reference signals (UE-specific Reference Signals).”

### (Base Station)

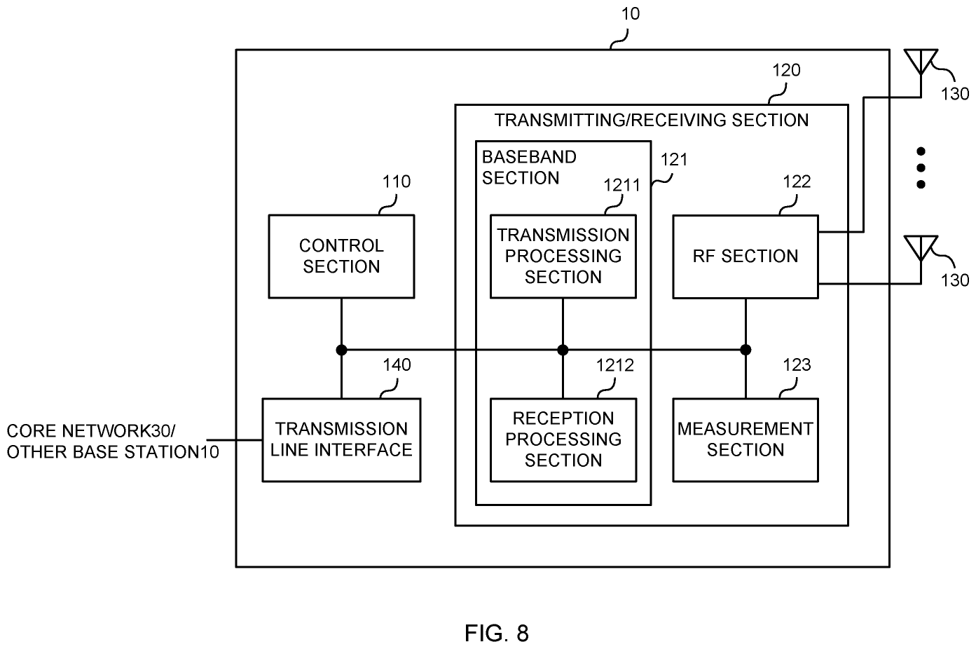

FIG. 8 is a diagram illustrating an example of a configuration of the base station according to one embodiment. The base station 10 includes a control section 110, a transmitting/receiving section 120, a transmitting/receiving antenna 130, and a transmission line interface 140. Note that one or more of the control sections 110, one or more of the transmitting/receiving sections 120, one or more of the transmitting/receiving antennas 130, and one or more of the transmission line interfaces 140 may be included.

Note that this example mainly describes a functional block which is a characteristic part of the present embodiment, and it may be assumed that the base station 10 also has another functional block necessary for radio communication. A part of processing of each section described below may be omitted.

The control section 110 controls the entire base station 10. The control section 110 can be constituted by a controller, a control circuit, or the like, which is described based on common recognition in the technical field to which the present disclosure relates.

The control section 110 may control signal generation, scheduling (for example, resource allocation or mapping), and the like. The control section 110 may control transmission/reception, measurement, and the like using the transmitting/receiving section 120, the transmitting/receiving antenna 130, and the transmission line interface 140. The control section 110 may generate data to be transmitted as a signal, control information, a sequence, and the like, and may forward the data, the control information, the sequence, and the like to the transmitting/receiving section 120. The control section 110 may perform call processing (such as configuration or releasing) of a communication channel, management of the state of the base station 10, and management of a radio resource.

The transmitting/receiving section 120 may include a baseband section 121, a radio frequency (RF) section 122, and a measurement section 123. The baseband section 121 may include a transmission processing section 1211 and a reception processing section 1212. The transmitting/receiving section 120 can be constituted by a transmitter/receiver, an RF circuit, a base band circuit, a filter, a phase shifter, a measurement circuit, a transmission/reception circuit, and the like, which are described based on common recognition in the technical field to which the present disclosure relates.

The transmitting/receiving section 120 may be constituted as an integrated transmitting/receiving section, or may be constituted by a transmission section and a reception section. The transmitting section may include the transmission processing section 1211 and the RF section 122. The reception section may be constituted by the reception processing section 1212, the RF section 122, and the measurement section 123.

The transmitting/receiving antenna 130 can be constituted by an antenna described based on common recognition in the technical field to which the present disclosure relates, for example, an array antenna.

The transmitting/receiving section 120 may transmit the above-described downlink channel, synchronization signal, downlink reference signal, and the like. The transmitting/receiving section 120 may receive the above-described uplink channel, uplink reference signal, and the like.

The transmitting/receiving section 120 may form at least one of a Tx beam and a reception beam by using digital beam forming (for example, precoding), analog beam forming (for example, phase rotation), and the like.

The transmitting/receiving section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like on, for example, data, control information, and the like acquired from the control section 110, to generate a bit string to be transmitted.

The transmitting/receiving section 120 (transmission processing section 1211) may perform transmission processing such as channel encoding (which may include error correction encoding), modulation, mapping, filtering processing, discrete Fourier transform (DFT) processing (if necessary), inverse fast Fourier transform (IFFT) processing, precoding, or digital-analog conversion on the bit string to be transmitted, to output a base band signal.

The transmitting/receiving section 120 (RF section 122) may perform modulation to a radio frequency band, filtering processing, amplification, and the like on the base band signal, and may transmit a signal in the radio frequency band via the transmitting/receiving antenna 130.

Meanwhile, the transmitting/receiving section 120 (RF section 122) may perform amplification, filtering processing, demodulation to a base band signal, and the like on the signal in the radio frequency band received by the transmitting/receiving antenna 130.

The transmitting/receiving section 120 (reception processing section 1212) may apply reception processing such as analog-digital conversion, fast Fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired base band signal, to acquire user data and the like.

The transmitting/receiving section 120 (measurement section 123) may perform measurement on the received signal. For example, the measurement section 123 may perform radio resource management (RRM) measurement, channel state information (CSI) measurement, and the like based on the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. The measurement result may be output to the control section 110.

The transmission line interface 140 may transmit/receive a signal (backhaul signaling) to and from an apparatus included in the core network 30, other base stations 10, and the like, and may acquire, transmit, and the like user data (user plane data), control plane data, and the like for the user terminal 20.

Note that the transmission section and the reception section of the base station 10 in the present disclosure may be constituted by at least one of the transmitting/receiving section 120, the transmitting/receiving antenna 130, and the transmission line interface 140.

The transmitting/receiving section 120 may transmit a configuration of a physical uplink control channel (PUCCH) for a scheduling request (SR) and channel state information (CSI). The control section 110 may control reception of a plurality of repetitions of the PUCCH respectively transmitted over a plurality of subslots based on the configuration.

### (User Terminal)

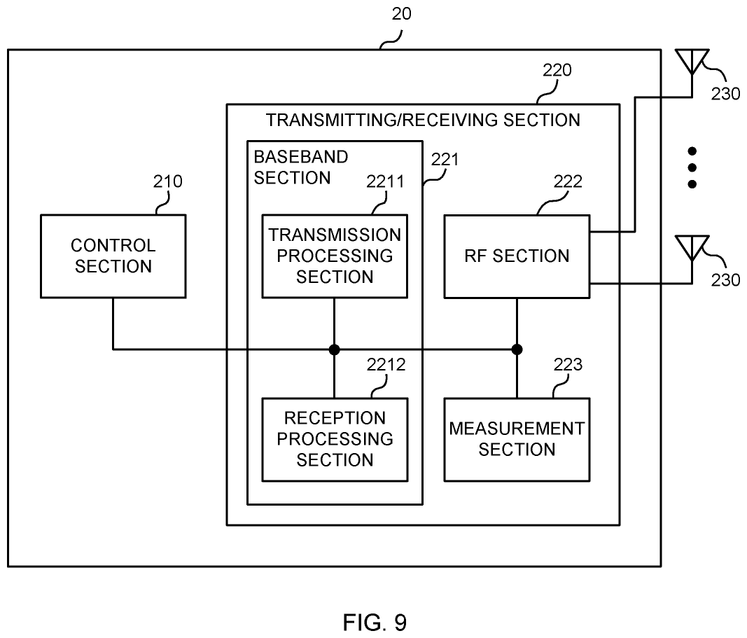

FIG. 9 is a diagram illustrating an example of a configuration of the user terminal according to one embodiment. The user terminal 20 includes a control section 210, a transmitting/receiving section 220, and a transmitting/receiving antenna 230. Note that one or more of the control sections 210, one or more of the transmitting/receiving sections 220, and one or more of the transmitting/receiving antennas 230 may be included.

Note that, although this example mainly describes a functional block which is a characteristic part of the present embodiment, it may be assumed that the user terminal 20 also has another functional block necessary for radio communication. A part of processing of each section described below may be omitted.

The control section 210 controls the entire user terminal 20. The control section 210 can be constituted by a controller, a control circuit, or the like, which is described based on common recognition in the technical field to which the present disclosure relates.

The control section 210 may control signal generation, mapping, and the like. The control section 210 may control transmission/reception, measurement, and the like using the transmitting/receiving section 220 and the transmitting/receiving antenna 230. The control section 210 may generate data to be transmitted as a signal, control information, a sequence, and the like, and may transfer the data, the control information, the sequence, and the like to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted by a transmitter/receiver, an RF circuit, a baseband circuit, a filter, a phase shifter, a measurement circuit, a transmission/reception circuit, and the like, which are described based on common recognition in the technical field to which the present disclosure relates.

The transmitting/receiving section 220 may be constituted as an integrated transmitting/receiving section, or may be constituted by a transmission section and a reception section. The transmitting section may include the transmission processing section 2211 and the RF section 222. The reception section may be constituted by the reception processing section 2212, the RF section 222, and the measurement section 223.

The transmitting/receiving antenna 230 can be constituted by an antenna described based on common recognition in the technical field to which the present disclosure relates, for example, an array antenna.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a transmission beam and a reception beam by using digital beam forming (for example, precoding), analog beam forming (for example, phase rotation), and the like.

The transmitting/receiving section 220 (transmission processing section 2211) may perform PDCP layer processing, RLC layer processing (for example, RLC retransmission control), MAC layer processing (for example, HARQ retransmission control), and the like, for example, on data acquired from the control section 210 or control information to generate a bit string to be transmitted.

The transmitting/receiving section 220 (transmission processing section 2211) may perform transmission processing such as channel encoding (which may include error correction encoding), modulation, mapping, filtering processing, DFT processing (if necessary), IFFT processing, precoding, or digital-analog transform on a bit string to be transmitted, and may output a baseband signal.

Note that whether or not to apply DFT processing may be determined based on configuration of transform precoding. When transform precoding is enabled for a channel (for example, PUSCH), the transmitting/receiving section 220 (transmission processing section 2211) may perform DFT processing as the transmission processing in order to transmit the channel using a DFT-s-OFDM waveform. When transform precoding is not enabled for a channel (for example, PUSCH), the transmitting/receiving section 220 (transmission processing section 2211) does not have to perform DFT processing as the transmission processing.

The transmitting/receiving section 220 (RF section 222) may perform modulation to a radio frequency band, filtering processing, amplification, and the like on the baseband signal, and may transmit a signal in the radio frequency band via the transmitting/receiving antenna 230.

Meanwhile, the transmitting/receiving section 220 (RF section 222) may perform amplification, filtering processing, demodulation to a baseband signal, and the like on the signal in the radio frequency band received by the transmitting/receiving antenna 230.

The transmitting/receiving section 220 (reception processing section 2212) may acquire user data and the like by applying reception processing such as analog-digital transform, FFT processing, IDFT processing (if necessary), filtering processing, demapping, demodulation, decoding (which may include error correction decoding), MAC layer processing, RLC layer processing, or PDCP layer processing on the acquired baseband signal.

The transmitting/receiving section 220 (measurement section 223) may perform measurement on the received signal. For example, the measurement section 223 may perform RRM measurement, CSI measurement, and the like based on the received signal. The measurement section 223 may measure received power (for example, RSRP), received quality (for example, RSRQ, SINR, or SNR), signal strength (for example, RSSI), propagation path information (for example, CSI), and the like. The measurement result may be output to the control section 210.

Note that the transmitting section and the receiving section of the user terminal 20 in the present disclosure may include at least one of the transmitting/receiving section 220 or the transmitting/receiving antenna 230.

The transmitting/receiving section 220 may receive a configuration of a physical uplink control channel (PUCCH) for a scheduling request (SR) and channel state information (CSI). The control section 210 may control respective transmission of a plurality of repetitions of the PUCCH over a plurality of subslots on the basis of the configuration.

A start symbol index of each of the plurality of repetitions may be configured by a relative value to a first symbol of a subslot.

In the configuration, at least one value of the periodicity and the offset of the PUCCH may be the number of subslots or may be interpreted as the number of subslots.

A start symbol index of each of the plurality of repetitions may be configured by a relative value to a first symbol of a slot.

### (Hardware Configuration)

Note that the block diagrams that have been used to describe the above embodiments illustrate blocks in functional units. These functional blocks (components) may be implemented in arbitrary combinations of at least one of hardware or software. In addition, the method for implementing each functional block is not particularly limited. That is, each functional block may be implemented by a single apparatus physically or logically aggregated, or may be implemented by directly or indirectly connecting two or more physically or logically separate apparatuses (in a wired manner, a radio manner, or the like, for example) and using these apparatuses. The functional blocks may be implemented by combining software with the above-described single apparatus or the above-described plurality of apparatuses.

Here, the function includes, but is not limited to, determining, judging, calculating, computing, processing, deriving, investigating, searching, ascertaining, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like. For example, a functional block (component) that has a transmission function may be referred to as a transmitting section (transmitting unit), a transmitter, and the like. In any case, as described above, the implementation method is not particularly limited.

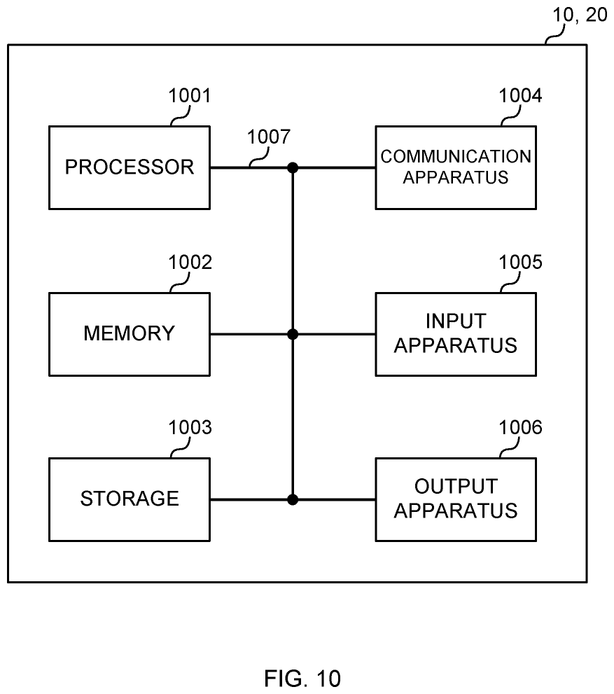

For example, the base station, the user terminal, and the like according to one embodiment of the present disclosure may function as a computer that executes the processing of the radio communication method of the present disclosure. FIG. 10 is a diagram illustrating an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

Note that in the present disclosure, the terms such as an apparatus, a circuit, a device, a section, or a unit can be replaced with each other. The hardware configuration of the base station 10 and the user terminal 20 may include one or more of each of the apparatuses illustrated in the drawings, or does not have to include some apparatuses.

For example, although only one processor 1001 is shown, a plurality of processors may be provided. In addition, the processing may be executed by one processor, or the processing may be executed by two or more processors simultaneously or sequentially, or using other methods. Note that the processor 1001 may be implemented with one or more chips.

Each of functions of the base station 10 and the user terminal 20 is, for example, implemented by causing certain software (program) to be read on hardware such as the processor 1001 or the memory 1002 to thereby cause the processor 1001 to perform operation, control communication via the communication apparatus 1004, and control at least one of reading or writing of data from or in the memory 1002 and the storage 1003.

The processor 1001 may control the whole computer by, for example, running an operating system. The processor 1001 may be implemented by a central processing unit (CPU) including an interface with peripheral equipment, a control apparatus, an operation apparatus, a register, and the like. For example, at least a part of the above-described control section 110 (210), transmitting/receiving section 120 (220), and the like may be implemented by the processor 1001.

Furthermore, the processor 1001 reads programs (program code), software modules, data, and so on from at least one of the storage 1003 or the communication apparatus 1004 into the memory 1002, and executes various types of processing according to these. As for the programs, programs to allow computers to execute at least part of the operations of the above-described embodiments may be used. For example, the control section 110 (210) may be implemented by a control program that is stored in the memory 1002 and that operates on the processor 1001, and other functional blocks may be implemented likewise.

The memory 1002 is a computer-readable recording medium, and may include, for example, at least one of a read only memory (ROM), an erasable programmable ROM (EPROM), an electrically EPROM (EEPROM), a random access memory (RAM), or other appropriate storage media. The memory 1002 may be referred to as a register, a cache, a main memory (primary storage apparatus), and the like. The memory 1002 can store a program (program code), a software module, and the like, which are executable for implementing the radio communication method according to one embodiment of the present disclosure.

The storage 1003 is a computer-readable recording medium, and may include, for example, at least one of a flexible disk, a floppy (registered trademark) disk, a magneto-optical disk (for example, a compact disc ROM (CD-ROM) and the like), a digital versatile disc, a Blu-ray (registered trademark) disk), a removable disk, a hard disk drive, a smart card, a flash memory device (for example, a card, a stick, or a key drive), a magnetic stripe, a database, a server, or other appropriate storage media. The storage 1003 may be referred to as “secondary storage apparatus.”

The communication apparatus 1004 is hardware (transmitting/receiving device) for performing inter-computer communication via at least one of a wired network or a wireless network, and for example, is referred to as “network device”, “network controller”, “network card”, “communication module”, and the like. The communication apparatus 1004 may include a high frequency switch, a duplexer, a filter, a frequency synthesizer, and the like in order to implement, for example, at least one of frequency division duplex (FDD) or time division duplex (TDD). For example, the transmitting/receiving section 120 (220), the transmitting/receiving antenna 130 (230), and the like described above may be implemented by the communication apparatus 1004. The transmitting/receiving section 120 (220) may be implemented in a physically or logically separated manner by the transmission section 120a (220a) and the reception section 120b (220b).

The input apparatus 1005 is an input device for receiving input from the outside (for example, a keyboard, a mouse, a microphone, a switch, a button, a sensor and so on). The output apparatus 1006 is an output device that performs output to the outside (for example, a display, a speaker, a light emitting diode (LED) lamp, or the like). Note that the input apparatus 1005 and the output apparatus 1006 may be provided in an integrated structure (for example, a touch panel).

Furthermore, these pieces of apparatus (these apparatus), including the processor 1001, the memory 1002 and so on are connected by the bus 1007 so as to communicate information. The bus 1007 may be formed with a single bus, or may be formed with buses that vary between pieces of apparatus (between apparatus).

Further, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by the hardware. For example, the processor 1001 may be implemented with at least one of these pieces of hardware (these hardware).

### (Variations)

Note that terms described in the present disclosure and terms necessary for understanding the present disclosure may be replaced with terms that have the same or similar meanings. For example, a channel, a symbol, and a signal (signal or signaling) may be replaced with each other. In addition, the signal may be a message. A reference signal can be abbreviated as an RS, and may be referred to as a pilot, a pilot signal, and the like, depending on which standard applies. Further, a component carrier (CC) may be referred to as a cell, a frequency carrier, a carrier frequency, and the like.

A radio frame may include one or more periods (frames) in the time domain. Each of the one or more periods (frames) included in the radio frame may be referred to as a subframe. Further, the subframe may include one or more slots in the time domain. The subframe may be a fixed time duration (for example, 1 ms) that is not dependent on numerology.

Here, the numerology may be a communication parameter used for at least one of transmission or reception of a certain signal or channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in the frequency domain, specific windowing processing performed by a transceiver in the time domain, and the like.

The slot may include one or more symbols in the time domain (orthogonal frequency division multiplexing (OFDM) symbols, single carrier frequency division multiple access (SC-FDMA) symbols, and the like). Also, a slot may be a time unit based on numerology.

The slot may include a plurality of mini slots. Each mini slot may include one or more symbols in the time domain. in addition, the mini slot may be referred to as a subslot. Each mini slot may include fewer symbols than the slot. A PDSCH (or PUSCH) transmitted in a time unit larger than the mini slot may be referred to as PDSCH (PUSCH) mapping type A. A PDSCH (or PUSCH) transmitted using the mini slot may be referred to as “PDSCH (PUSCH) mapping type B”.

A radio frame, a subframe, a slot, a mini slot and a symbol all represent the time unit in signal communication. A radio frame, a subframe, a slot, a mini slot, and a symbol may be each called by other applicable names. Note that time units such as the frame, the subframe, the slot, the mini slot, and the symbol in the present disclosure may be interchangeable.

For example, one subframe may be referred to as a TTI, a plurality of consecutive subframes may be referred to as a TTI, or one slot or one mini slot may be referred to as a TTI. That is, at least one of the subframe or the TTI may be a subframe (1 ms) in the existing LTE, may be a period shorter than 1 ms (for example, one to thirteen symbols), or may be a period longer than 1 ms. Note that the unit to represent the TTI may be referred to as a “slot,” a “mini slot” and so on, instead of a “subframe.”

Here, a TTI refers to the minimum time unit of scheduling in radio communication, for example. For example, in the LTE system, a base station performs scheduling to allocate radio resources (a frequency bandwidth, transmit power, and the like that can be used in each user terminal) to each user terminal in TTI units. Note that the definition of TTIs is not limited to this.

The TTI may be the transmission time unit of channel-encoded data packets (transport blocks), code blocks, codewords, or the like, or may be the unit of processing in scheduling, link adaptation, or the like. Note that when the TTI is given, a time interval (for example, the number of symbols) in which the transport block, the code block, the codeword, or the like is actually mapped may be shorter than the TTI.

Note that, when one slot or one mini slot is referred to as a “TTI,” one or more TTIs (that is, one or multiple slots or one or more mini slots) may be the minimum time unit of scheduling. Also, the number of slots (the number of mini slots) to constitute this minimum time unit of scheduling may be controlled.

A TTI having a time duration of 1 ms may also be referred to as a usual TTI (TTI in 3GPP Rel. 8 to 12), a normal TTI, a long TTI, a usual subframe, a normal subframe, a long subframe, a slot, or the like. A TTI shorter than the usual TTI may be referred to as a shortened TTI, a short TTI, a partial TTI (or fractional TTI), a shortened subframe, a short subframe, a mini slot, a sub-slot, a slot, or the like.

Note that a long TTI (for example, a usual TTI, a subframe, etc.) may be replaced with a TTI having a time duration exceeding 1 ms, and a short TTI (for example, a shortened TTI) may be replaced with a TTI having a TTI duration less than the TTI duration of a long TTI and not less than 1 ms.

A resource block (RB) is the unit of resource allocation in the time domain and the frequency domain, and may include one or more contiguous subcarriers in the frequency domain. The number of subcarriers included in an RB may be the same regardless of the numerology, and may be 12, for example. The number of subcarriers included in the RB may be determined on the basis of the numerology.

Also, an RB may include one or more symbols in the time domain, and may be one slot, one mini slot, one subframe or one TTI in length. One TTI, one subframe, and the like each may include one or more resource blocks.

Note that one or more RBs may be referred to as a physical resource block (PRB), a subcarrier group (SCG), a resource element group (REG), a PRB pair, an RB pair, and the like.

Furthermore, a resource block may include one or more resource elements (REs). For example, one RE may be a radio resource field of one subcarrier and one symbol.

A bandwidth part (BWP) (which may be referred to as a partial bandwidth or the like) may represent a subset of contiguous common resource blocks (RBs) for a certain numerology in a certain carrier. Here, the common RB may be specified by the index of the RB based on a common reference point of the carrier. The PRB may be defined in a certain BWP and be numbered within the BWP.

The BWP may include a BWP for UL (UL BWP) and a BWP for DL (DL BWP). For the UE, one or more BWPs may be configured within one carrier.

At least one of the configured BWPs may be active, and the UE may not assume to transmit or receive a certain channel/signal outside the active BWP. Note that “cell”, “carrier”, and the like in the present disclosure may be replaced with “BWP”.

Note that the structures of radio frames, subframes, slots, mini slots, symbols and so on described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the length of cyclic prefix (CP), and the like can be variously changed.

Furthermore, information, a parameter, or the like described in the present disclosure may be represented in absolute values, represented in relative values with respect to certain values, or represented by using other corresponding information. For example, a radio resource may be specified by a certain index.

The names used for parameters and the like in the present disclosure are in no respect limiting. Further, any mathematical expression or the like that uses these parameters may differ from those explicitly disclosed in the present disclosure. Since various channels (PUCCH, PDCCH, and the like) and information elements can be identified by any suitable names, various names assigned to these various channels and information elements are not restrictive names in any respect.

The information, signals, and the like described in the present disclosure may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Further, information, signals, and the like can be output in at least one of a direction from higher layers to lower layers or a direction from lower layers to higher layers. Information, signals and so on may be input and output via a plurality of network nodes.

The information, signals and so on that are input and/or output may be stored in a specific location (for example, in a memory), or may be managed in a control table. The information, signals, and the like to be input and output can be overwritten, updated, or appended. The output information, signals, and the like may be deleted. The information, signals and the like that are input may be transmitted to other pieces of apparatus (other apparatus).

Notification of information may be performed not only by using the aspects/embodiments described in the present disclosure but also using another method. For example, the notification of information in the present disclosure may be performed by using physical layer signaling (for example, downlink control information (DCI) or uplink control information (UCI)), higher layer signaling (for example, radio resource control (RRC) signaling, broadcast information (master information block (MIB)), system information block (SIB), or the like), or medium access control (MAC) signaling, another signal, or a combination thereof.

Note that the physical layer signaling may be referred to as Layer 1/Layer 2 (L1/L2) control information (L1/L2 control signal), L1 control information (L1 control signal), and the like. In addition, the RRC signaling may be referred to as an RRC message, and may be, for example, an RRC connection setup message, an RRC connection reconfiguration message, and the like. Further, notification of the MAC signaling may be performed using, for example, an MAC control element (CE).

Also, reporting of certain information (for example, reporting of information to the effect that “X holds”) does not necessarily have to be sent explicitly, and can be sent implicitly (for example, by not reporting this piece of information, by reporting another piece of information, and so on).

Decisions may be made in values represented by one bit (0 or 1), may be made in Boolean values that represent true or false, or may be made by comparing numerical values (for example, comparison against a certain value).

Software, whether referred to as “software”, “firmware”, “middleware”, “microcode” or “hardware description language”, or called by other names, should be interpreted broadly, to mean instructions, instruction sets, code, code segments, program codes, programs, subprograms, software modules, applications, software applications, software packages, routines, subroutines, objects, executable files, execution threads, procedures, functions and the like.

Also, software, instructions, information and so on may be transmitted and received via communication media. For example, when software is transmitted from a website, a server, or another remote source by using at least one of a wired technology (coaxial cable, optical fiber cable, twisted pair, digital subscriber line (DSL), or the like) and a wireless technology (infrared rays, microwaves, and the like), at least one of the wired technology or the wireless technology is included within the definition of a transmission medium.

The terms “system” and “network” used in the present disclosure can be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmission power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be used interchangeably.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station may be referred to as a term such as a macro cell, a small cell, a femto cell, or a pico cell.

The base station can accommodate one or more (for example, three) cells. In a case where the base station accommodates a plurality of cells, the entire coverage area of the base station can be partitioned into a plurality of smaller areas, and each smaller area can provide communication services through a base station subsystem (for example, small base station for indoors (remote radio head (RRH))). The term “cell” or “sector” refers to a part or the whole of a coverage area of at least one of a base station or a base station subsystem that performs a communication service in this coverage.

In the present disclosure, the terms such as mobile station (MS)”, “user terminal”, “user equipment (UE)”, and “terminal” can be used interchangeably.

The mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

At least one of the base station or the mobile station may be referred to as a transmitting apparatus, a receiving apparatus, a radio communication apparatus, and the like. Note that at least one of the base station or the mobile station may be a device mounted on a moving object, a moving object itself, and the like. The moving object may be a transportation (for example, a car, an airplane, or the like), an unmanned moving object (for example, a drone, an autonomous car, or the like), or a (manned or unmanned) robot. Note that at least one of the base station or the mobile station also includes an apparatus that does not necessarily move during a communication operation. For example, at least one of the base station or the mobile station may be an Internet of Things (IoT) device such as a sensor.

Further, the base station in the present disclosure may be replaced with the user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In this case, the user terminal 20 may have the function of the above-described base station 10. In addition, terms such as “uplink” and “downlink” may be replaced with a term corresponding to communication between terminals (for example, “side”). For example, the uplink channel, the downlink channel, and the like may be replaced with a side channel.

Likewise, the user terminals in the present disclosure may be interpreted as base stations. In this case, the base stations 10 may have the functions of the user terminals 20 described above.

In the present disclosure, an operation performed by a base station may be performed by an upper node thereof in some cases. In a network including one or more network nodes with base stations, it is clear that various operations performed for communication with a terminal can be performed by a base station, one or more network nodes (examples of which include but are not limited to mobility management entity (MME) and serving-gateway (S-GW)) other than the base station, or a combination thereof.

The aspects/embodiments illustrated in the present disclosure may be used individually or in combinations, which may be switched depending on the mode of implementation, in addition, the order of processing procedures, sequences, flowcharts, and the like of the aspects/embodiments described in the present disclosure may be re-ordered as long as there is no inconsistency. For example, regarding the methods described in the present disclosure, elements of various steps are presented using an illustrative order, and are not limited to the presented specific order.

Each aspect/embodiment described in the present disclosure may be applied to a system using long term evolution (LTE), LTE-advanced (LTE-A), LTE-beyond (LTE-B), SUPER 3G, IMT-Advanced, 4th generation mobile communication system (4G), 5th generation mobile communication system (5G), 6th generation mobile communication system (6G), xth generation mobile communication system (xG) (x is, for example, an integer or decimal), future radio access (FRA), new radio access technology (RAT), new radio (NR), new radio access (NX), future generation radio access (FX), global system for mobile communications (GSM (registered trademark)), CDMA 2000, ultra mobile broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or another appropriate radio communication method, a next generation system expanded based on these, and the like. Further, a plurality of systems may be combined and applied (for example, a combination of LTE or LTE-A and 5G, and the like).

The phrase “based on” as used in the present disclosure does not mean “based only on”, unless otherwise specified. In other words, the phrase “based on” means both “based only on” and “based at least on”.

Any reference to an element using designations such as “first” and “second” used in the present disclosure does not generally limit the amount or order of these elements. These designations can be used in the present disclosure, as a convenient way of distinguishing between two or more elements. In this way, reference to the first and second elements does not imply that only two elements may be employed, or that the first element must precede the second element in some way.

The term “determining” as used in the present disclosure may include a wide variety of operations. For example, “determining” may be interpreted to mean making judgements and determinations related to judging, calculating, computing, processing, deriving, investigating, looking up, search, inquiry (for example, looking up in a table, database, or another data structure), ascertaining, and the like.

Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on.

In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

Furthermore, “determining” may be replaced with “assuming”, “expecting”, “considering”, and the like.

The terms “connected” and “coupled” used in the present disclosure, or any variation of these terms mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be replaced with “access”.

In the present disclosure, when two elements are connected together, it is conceivable that the two elements are “connected” or “coupled” to each other by using one or more electrical wires, cables, printed electrical connections, and the like, and, as some non-limiting and non-inclusive examples, by using electromagnetic energy having wavelengths in the radio frequency domain, microwave region, or optical (both visible and invisible) region, or the like.

In the present disclosure, the phrase “A and B are different” may mean “A and B are different from each other”. Note that the phrase may mean that “A and B are different from C”. The terms such as “separate”, “coupled”, and the like may be interpreted similarly to “different”.

When “include”, “including”, and variations of these are used in the present disclosure, these terms are intended to be inclusive similarly to the term “comprising”. Further, the term “or” as used in the present disclosure is intended to be not an exclusive-OR.

In the present disclosure, when articles are added by translation, for example, as a, an, and the in English, the present disclosure may include that nouns that follow these articles are plural.

Although the invention according to the present disclosure has been described in detail above, it is obvious to those skilled in the art that the invention according to the present disclosure is not limited to the embodiments described in the present disclosure. The invention according to the present disclosure can be embodied with various corrections and in various modified aspects, without departing from the spirit and scope of the invention defined on the basis of the description of claims. Therefore, the description of the present disclosure is provided only for the purpose of explaining examples, and should by no means be construed to limit the invention according to the present disclosure in any way.

The present application is based on Japanese Patent Application No. 2021-137354 filed on Aug. 25, 2021. The contents of this are all incorporated herein.

1. A terminal comprising:
a receiving section configured to receive a configuration of a physical uplink control channel (PUCCH) for at least one of a scheduling request (SR) and channel state information (CSI); and
a control section configured to control respective transmission of a plurality of repetitions of the PUCCH over a plurality of subslots based on the configuration.

2. The terminal according to claim 1, wherein a start symbol index of each of the plurality of repetitions is configured by a relative value to a first symbol of a subslot.

3. The terminal according to claim 2, wherein in the configuration, at least one value of a periodicity and an offset of the PUCCH is the number of subslots or is interpreted as the number of subslots.

4. The terminal according to claim 1, wherein a start symbol index of each of the plurality of repetitions is configured by a relative value to a first symbol of a slot.

5. A radio communication method of a terminal, the radio communication method comprising:
receiving a configuration of a physical uplink control channel (PUCCH) for at least one of a scheduling request (SR) and channel state information (CSI); and
controlling respective transmission of a plurality of repetitions of the PUCCH over a plurality of subslots based on the configuration.

6. A base station comprising:
a transmitting section configured to transmit a configuration of a physical uplink control channel (PUCCH) for at least one of a scheduling request (SR) and channel state information (CSI); and
a control section configured to control reception of a plurality of repetitions of the PUCCH respectively transmitted over a plurality of subslots based on the configuration.
